(19) United States
(12) Patent Application Publication
(10) Pub. No.: US 2025/0282357 A1
(43) Pub. Date: Sep. 11, 2025

(54) Method and Device for Controlling the Coasting Mode of a Motor Vehicle With Respect to a Coasting Entry Phase

(71) Applicant: Bayerische Motoren Werke Aktiengesellschaft, Muenchen (DE)

(72) Inventors: Helena DOLINAJ, Muenchen (DE); Miguel LOENNE, Muenchen (DE); Sebastien MATHIEU, Fuerstenfeldbruck (DE)

(21) Appl. No.: 18/861,909

(22) PCT Filed: Apr. 21, 2023
(86) PCT No.: PCT/EP2023/060384

§ 371 Date: Oct. 31, 2024

(30) Foreign Application Priority Data
May 6, 2022 (DE) 10 2022 111 305.1

(51) Int. Cl. B60W 30/18; B60W 50/00

(52) U.S. Cl. CPC B60W 30/18072; B60W 50/0097; B60W 2030/1809; B60W 2720/103

(57) ABSTRACT

A device for controlling the coasting mode of a vehicle in the context of a distance control and/or speed control function of the vehicle is provided. The device is designed to predict a distance and/or speed progression of the vehicle in the coasting mode taking into account a movement of the vehicle during a coasting entry phase. The device is also designed to control the coasting mode in accordance with the predicted distance and/or speed progression.

### BACKGROUND AND SUMMARY

The invention relates to a motor vehicle designed to be operated in a coasting mode. In particular, the invention relates to a method and a corresponding device for controlling the coasting mode of a motor vehicle.

A vehicle having an internal combustion engine can be designed to temporarily decouple the internal combustion engine from the drivetrain of the vehicle during a journey and possibly deactivate it to reduce the energy consumption of the vehicle. In other words, the vehicle can be designed to be temporarily operated in the coasting mode during a journey.

The present document relates to the technical problem of enabling a particularly energy-efficient coasting mode of a vehicle, in particular in conjunction with distance control and/or speed control of the vehicle.

The object is achieved by each of the independent claims. Advantageous embodiments are described, inter alia, in the dependent claims. It is noted that additional features of a claim dependent on an independent claim, without the features of the independent claim or only in combination with a subset of the features of the independent claim, can form a separate invention independent of the combination of all features of the independent claim, which can be made the subject matter of an independent claim, a divisional application, or a subsequent application. This applies in the same manner to technical teachings described in the description which can form an invention independent of the features of the independent claims.

According to one aspect, a (control) device for controlling the coasting mode of a (motor) vehicle in the context of distance and/or speed control of the vehicle is described. During the operation of the distance and/or speed control, the driving speed can be adapted automatically in dependence on a target distance (defined by the driver) to the preceding vehicle driving (directly) in front of the vehicle and/or (during a free drive) in dependence on a target speed (defined by the driver), in particular controlled (to the target distance and/or to the target speed).

The device can be configured to decouple the drive motor (in particular the internal combustion engine) of the vehicle from the drivetrain of the vehicle (and possibly to deactivate the drive motor) in order to start the coasting mode. Alternatively or additionally, the device can be configured to couple the drive motor to the drivetrain of the vehicle (and possibly to activate the drive motor) in order to end the coasting mode. The vehicle can roll in the coasting mode without action of a drive torque and/or a drag torque of the drive motor.

During the coasting mode of the vehicle, typically no drive torque is therefore caused by the drive motor of the vehicle. No braking torque (due to one or more friction brakes of the vehicle) can possibly also be effected during the coasting mode. Therefore, possibly no active distance and/or speed control can take place during the coasting mode. However, it can be monitored in this case that during the coasting mode the distance of the vehicle to the preceding vehicle remains within a predefined tolerance band around the target distance and/or that the driving speed of the vehicle remains within a predefined tolerance band around the target speed. Active distance and/or speed control (to the target distance or to the target speed) can take place outside the coasting mode. In particular, in this case it is possible to cause the distance and/or the driving speed to be adjusted to the target distance or to the target speed directly after ending the coasting mode.

The device is configured to predict a distance and/or speed profile of the vehicle in the coasting mode proceeding from a current driving progression of the vehicle (for example, proceeding from the current time and/or proceeding from the current position). The predicted distance and/or speed profile can indicate the temporal and/or spatial distance of the vehicle to the preceding vehicle driving (directly) in front of the vehicle and/or the driving speed of the vehicle as a function of the driving progression (proceeding from the current driving progression). The predicted distance and/or speed profile can extend here proceeding from the current driving progression over a predefined prediction horizon.

The driving progression can indicate the position of the vehicle along the roadway traveled by the vehicle or correspond thereto. Alternatively or additionally, the driving progression can indicate the respective point in time during the journey of the vehicle or correspond thereto. The prediction horizon can therefore correspond to a specific distance and/or time horizon (e.g., 100 meters or more, or 500 meters or more; or 10 seconds or more, or 20 seconds or more).

The device can be configured to ascertain an upcoming gradient profile of the roadway traveled by the vehicle (for the prediction horizon). This information can be ascertained on the basis of a digital map for the roadway network traveled by the vehicle. The distance and/or speed profile of the vehicle in the coasting mode can then be predicted in a precise manner on the basis of the upcoming gradient profile.

The device can furthermore be configured to ascertain status data with respect to the status (for example, the current driving speed) of the vehicle and/or with respect to the status (for example, the current driving speed) of the preceding vehicle driving in front of the vehicle. The distance and/or speed profile of the vehicle in the coasting mode can then be predicted in a particularly precise manner on the basis of the status data.

Upon the prediction of the distance and/or speed profile of the vehicle, it can be assumed that the vehicle is in the coasting mode during the entire prediction horizon. Furthermore, an assumption with respect to the behavior of the preceding vehicle during the prediction horizon can be made. For example, it can be assumed that the driving speed of the preceding vehicle remains constant during the entire prediction horizon.

The device is configured to predict the distance and/or speed profile of the vehicle in the coasting mode in consideration of the movement of the vehicle during a coasting entry phase. The movement of the vehicle during the coasting entry phase caused by the drive motor (in particular by the internal combustion engine) can be taken into consideration here. In particular, it can be taken into consideration that during the coasting entry phase, a drive torque or a drag torque is still caused by the drive motor on the one or more wheels of the vehicle (even if the entry into the coasting mode has already been initiated).

During the coasting entry phase, the drive motor (in particular the internal combustion engine) of the vehicle can be decoupled from the drivetrain, in particular from one or more (driven) wheels, of the vehicle. Furthermore, the drive motor can possibly be deactivated. These one or more actions can occupy a specific period of time and/or a specific driving distance (in general a specific driving progression range).

The coasting entry phase can extend in particular over a driving progression range which starts with an initial driving progression, at which the decoupling of the drive motor of the vehicle from the drivetrain, in particular from one or more (driven) wheels, of the vehicle is initiated, and which ends with an end driving progression, at which the drive motor is completely decoupled from the drivetrain, in particular from the one or more (driven) wheels. The coasting entry phase can have a temporal duration of 0.5 seconds or more, in particular of 1 second or more, and/or of 5 seconds or less.

Due to the consideration of the coasting entry phase, the distance and/or speed profile of the vehicle in the coasting mode can be predicted in a particularly precise manner, by which the energy efficiency of the vehicle can be increased.

The coasting mode can be controlled, in particular started or ended, in dependence on the predicted distance and/or speed profile.

The device can be configured in particular to compare the predicted distance and/or speed profile of the vehicle to the target distance or to a distance threshold value lying above the target distance. Alternatively or additionally, the device can be configured to compare the predicted distance and/or speed profile to the target speed or to a speed threshold value of the distance and/or speed control of the vehicle lying below the target speed. The following can be ascertained here in the scope of the comparison for example
the driving progression section in which the predicted distance and/or speed profile remains within a predefined tolerance band around the target distance and/or around the target speed; and/or
the driving progression at which the predicted distance and/or speed profile reaches the target distance or the distance threshold value or the target speed or the speed threshold value (and possibly subsequently exceeds or falls below it).

The coasting mode can then be controlled, in particular started or ended, in dependence on the comparison (in particular in dependence on the ascertained driving progression section and/or in dependence on the ascertained driving progression). A particularly energy-efficient and comfortable coasting mode of a vehicle having active distance and/or speed control can thus be effected. During the distance and/or speed control and/or during the coasting mode, it is possible to deviate here at least temporarily and/or within a specific tolerance band from the target distance and/or from the target speed. The tolerance band or the respective threshold value can be, for example, ±5% or less, or ±10% or less of the target distance or the target speed.

The device can be configured to take into consideration a drive and/or drag torque caused by the drive motor of the vehicle during the coasting entry phase and/or a (positive or negative) acceleration of the vehicle caused by the drive motor during the coasting entry phase in the ascertainment of the predicted distance and/or speed profile. The value of the drive and/or drag torque and/or the (positive or negative) acceleration can be ascertained by means of one or more status sensors of the vehicle. The distance and/or speed profile can be predicted in a particularly precise manner by the consideration of the drive and/or drag torque and/or the acceleration during the coasting entry phase.

The device can be configured to ascertain the value of the drive and/or drag torque and/or the (positive or negative) acceleration which is caused or was caused at the initial driving progression of the coasting entry phase by the drive motor of the vehicle on the drivetrain, in particular on the one or more (driven) wheels, of the vehicle. The predicted distance and/or speed profile can then be ascertained in a particularly precise and efficient manner on the basis of the ascertained value of the drive and/or drag torque and/or the acceleration.

The device can be configured to ascertain the predicted distance and/or speed profile under the assumption that (in particular if the influence of the roadway gradient of the roadway traveled by the vehicle is not taken into consideration) the driving speed of the vehicle at the beginning of the predicted distance and/or speed profile remains unchanged for a specific driving progression range. The specific driving progression range (in particular the length of the driving progression range) in which the driving speed of the vehicle remains unchanged can be ascertained here on the basis of the ascertained value of the drive and/or drag torque and/or the acceleration (at the initial driving progression). The predicted distance and/or speed profile can thus be ascertained in a particularly precise and efficient manner.

According to a further aspect, a (road) motor vehicle (in particular a passenger vehicle or a truck or a bus or a motorcycle) is described which comprises the (control) device described in this document.

According to a further aspect, a method for controlling the coasting mode of a vehicle in the context of distance and/or speed control of the vehicle is described. The method comprises predicting a distance and/or speed profile of the vehicle in the coasting mode in consideration of the movement (caused by the drive motor of the vehicle) of the vehicle during a coasting entry phase (during the entry into the coasting mode). The method furthermore comprises controlling, in particular starting or ending, the coasting mode in dependence on the predicted distance and/or speed profile.

According to a further aspect, a software (SW) program is described. The SW program can be configured to be executed on a processor (for example, on a control unit of a vehicle), and in order to thus carry out the method described in this document.

According to a further aspect, a storage medium is described. The storage medium can comprise an SW program which is configured to be executed on a processor and to thus carry out the method described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth in parentheses are to be understood as optional features.

The invention will be described in more detail hereinafter on the basis of exemplary embodiments. In the figures

### BRIEF DESCRIPTION OF THE DRAWINGS

FIG. 1 shows exemplary components of a vehicle;

FIG. 2a shows an exemplary driving situation of a vehicle;

FIG. 2b shows an exemplary gradient profile of a roadway;

FIG. 3 shows exemplary predicted distance and/or speed profiles during the coasting mode; and

FIG. 4 shows a flow chart of an exemplary method for controlling the coasting mode of a vehicle.

### DETAILED DESCRIPTION OF THE DRAWINGS

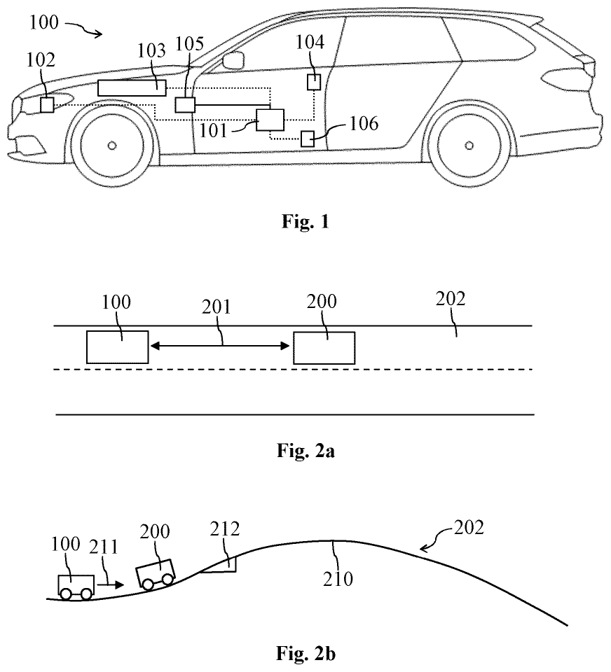

As described at the outset, the present document relates to increasing the energy efficiency and/or the comfort of the coasting mode of a motor vehicle. In this context, FIG. 1 shows an exemplary vehicle 100. The vehicle 100 comprises one or more surroundings sensors 102 (e.g., at least one camera, a radar sensor, a lidar sensor, and/or an ultrasonic sensor), which are configured to acquire surroundings data (i.e., sensor data) with respect to the surroundings of the vehicle 100. Furthermore, the vehicle 100 comprises one or more vehicle sensors 106, which are configured to acquire status data (i.e., sensor data) with respect to a status (for example, with respect to the driving speed) of the vehicle 100.

A (control) device 101 of the vehicle 100 can be configured to operate the drive motor 103 (in particular the internal combustion engine) of the vehicle 100 in dependence on the surroundings data and/or in dependence on the status data in order to longitudinally guide the vehicle 100 in an at least partially automated manner. In particular, automatic distance and/or speed control (in particular ACC, adaptive cruise control) can be effected here, in which the driving speed of the vehicle 100 is adjusted automatically in order to adjust the distance of the vehicle 100 to a preceding vehicle driving directly in front of the vehicle 100 to a target distance (which was defined by the driver of the vehicle 100, for example) and/or to adjust the driving speed of the vehicle 100 during a free drive (without preceding vehicle) to a target speed (which was defined by the driver of the vehicle 100, for example).

FIG. 2a shows an exemplary driving situation in which the vehicle 100 drives on a roadway 202 behind a preceding vehicle 200. The distance 201 between the vehicle 100 and the preceding vehicle 200 is set by the device 101 of the vehicle 100 to a specific target distance. The distance 201 can be a spatial distance here, which corresponds to the spatial distance (for example measured in meters) between the vehicle 100 and the preceding vehicle 200. Alternatively or additionally, the distance 201 can be a temporal distance, which corresponds to the time that the vehicle 100 would require at the current driving speed in order to reach the preceding vehicle 200 (under the assumption that the preceding vehicle 200 is stationary). The temporal distance can correspond, for example, to the quotient of the current driving speed of the vehicle 100 and the spatial distance between the vehicle 100 and the preceding vehicle 200.

The (control) device 101 can be configured to operate the vehicle 100 at least temporarily in a so-called coasting mode during active distance and/or speed control. For this purpose, the clutch 105 of the vehicle 100 can be prompted to decouple the drive motor 103 from the drivetrain of the vehicle 100, in particular from the one or more driven wheels of the vehicle 100. Furthermore, a deactivation and/or setting aside of the drive motor 103 can be effected. The vehicle 100 then rolls (without drag torque and/or without drive torque of the drive motor 103) over the roadway 202 traveled by the vehicle 100. The energy consumption of the vehicle 100 can thus be reduced.

The vehicle 100 can comprise a position sensor 104 which is configured to acquire position data (i.e., sensor data) with respect to the respectively current position of the vehicle 100. The position data can comprise, for example, coordinates of a global navigation satellite system (GNSS), such as GPS coordinates. The device 101 can be configured to ascertain the spatial profile of the roadway 202, on which the vehicle 100 will drive, on the basis of the position data and on the basis of a digital map with respect to the roadway network traveled by the vehicle 100. A driving route through the roadway network can optionally have been planned by means of a navigation system of the vehicle 100. It can be recognized on the basis of the driving route along which roadway 202 the vehicle 100 will drive preceding from the current time and/or proceeding from the current position. Furthermore, the spatial profile, in particular the gradient profile, of the upcoming roadway 202 can be ascertained on the basis of the digital map.

FIG. 2b shows an exemplary gradient profile 210 of the roadway 202 traveled by the vehicle 100. The gradient profile 210 indicates the gradient 212 of the roadway 202 as a function of the position on the roadway 202 and/or as a function of the time during a journey (generally as a function of the driving progression of the vehicle 100).

The device 101 can be configured to predict a distance profile and/or a speed profile of the vehicle 100 in the coasting mode on the basis of the gradient profile 210 of the upcoming roadway 202. The distance profile can indicate here the (temporal and/or spatial) distance 201 of the vehicle 100 to the preceding vehicle 200, as a function of the position and/or as a function of the time (generally as a function of the driving progression). The speed profile can indicate the driving speed of the vehicle 100 as a function of the position and/or as a function of the time (generally as a function of the driving progression). It can be assumed here that the vehicle 100 is operated in the coasting mode (without action of a drive and/or braking torque generated by the vehicle 100). Furthermore, (to ascertain the distance profile), a specific speed behavior of the preceding vehicle 200 can be assumed; for example, it can be assumed that the preceding vehicle 200 will drive at a constant driving speed. The distance profile and/or the speed profile can be predicted, for example, for a spatial prediction horizon of 50 meters or more, or of 100 meters or more (proceeding from the current position of the vehicle 100) and/or for a temporal prediction horizon of 5 seconds or more, or of 10 seconds or more.

The activation (also referred to as entry) and/or the deactivation (also referred to as exit) of the coasting mode of the vehicle 100 can be carried out in a precise and energy-efficient manner (during use of the distance and/or speed controller) in dependence on the predicted distance profile and/or in dependence on the predicted speed profile. In particular, the device 101 of the vehicle 100 can be configured (during the operation of the distance and/or speed controller) to predict a distance profile and/or a speed profile of the vehicle 100 in the coasting mode proceeding from the current position of the vehicle 100 and/or proceeding from the current time (generally, proceeding from the current driving progression). An entry into or an exit out of the coasting mode can then be effected in dependence on the predicted distance profile and/or speed profile.

The entry into the coasting mode typically extends over a specific coasting entry phase. One or more of the following process steps can be carried out during the coasting entry phase
actuating the clutch 105 in order to interrupt the operational connection between the drive motor 103 and the one or more driven wheels of the vehicle 100;
opening the clutch 105 in order to reduce the drive and/or drag torque caused by the drive motor 103 on the one or more driven wheels of the vehicle 100 to zero; and/or
deactivating the drive motor 103.

The coasting entry phase typically extends over a specific period of time and/or over a specific driving distance (in general over a specific driving progression range). For at least a part of the coasting entry phase, a drive and/or a drag torque can still be transmitted here from the drive motor 103 to the one or more driven wheels of the vehicle 100. In particular, a (positive or negative) acceleration of the vehicle 100 can possibly still be caused (by the drive motor 103).

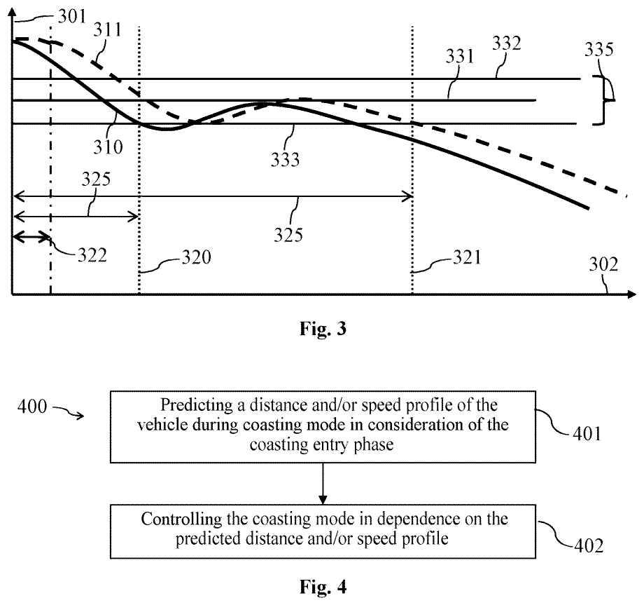

FIG. 3 shows an exemplary predicted distance and/or speed profile 310 during the coasting mode of the vehicle 100. As already described, the distance and/or speed profile 310 indicates the actual distance and/or the actual speed 301 of the vehicle 100 as a function of the driving progression 302 (for example, the position and/or the time) during the journey of the vehicle 100.

FIG. 3 furthermore shows an exemplary tolerance band 335 around the target distance and/or around the target speed 331, having a lower threshold value 333 and an upper threshold value 332, which include the target distance and/or the target speed 331. In FIG. 3, in particular a tolerance band 335 around the target speed 331 is shown (for speed control after exit from the coasting mode). The aspects described in this document are applicable accordingly for distance control after exit from the coasting mode.

The device 101 can be configured to determine on the basis of the predicted distance and/or speed profile 310 that the predicted distance and/or speed profile 310 will intersect a threshold value 332, 333 of the tolerance band 335 at an intersection driving progression 320 (in particular the lower threshold value 333 of the speed tolerance band 335 and/or the upper threshold value 332 of the distance tolerance band 335).

The device 101 can furthermore be configured to effect an exit from the coasting mode at an exit driving progression (which is before the intersection driving progression 320, for example, by a specific offset value) dependent on the intersection driving progression 320. The vehicle 100 can have an actual driving speed 301 at the exit driving progression, which lies below the target speed 331 (and/or can have an actual distance 301 which lies above the target distance 331).

The driving progression range 325, in which the vehicle 100 is in the coasting mode, can therefore depend on the predicted distance and/or speed profile 310. An inaccuracy of the prediction of the distance and/or speed profile 310 can have an effect here on the (temporal and/or route-related) length of the driving progression range 325 and therefore on the energy efficiency of the vehicle 100 (since the energy efficiency of the vehicle 100 typically increases with increasing length of the driving progression range 325 of the coasting mode).

The (control) device 101 can be configured to take the coasting entry phase, in particular the movement of the vehicle 100 during the coasting entry phase, into consideration in the forecast or in the prediction of the distance and/or speed profile 310. It can be taken into consideration in particular here that the vehicle 100 is at least temporarily still driven, decelerated, and/or accelerated (actively and/or by the drive motor 103) during the coasting entry phase. The accuracy of the predicted distance and/or speed profile 310 and therefore the energy efficiency of the vehicle 100 can thus be further increased.

FIG. 3 shows an exemplary predicted distance and/or speed profile 311, which was predicted in consideration of the movement (actively caused by the drive motor 103) of the vehicle 100 during the coasting entry phase. In particular, FIG. 3 shows an exemplary, predicted, speed profile 311. As is apparent from FIG. 3, the modified speed profile 311 has an elevated driving speed 301 in relation to the original speed profile 310 during the coasting entry phase 322, since the drive torque caused in the coasting entry phase 322 is taken into consideration. The increased speed 301 in the coasting entry phase 322 has an effect on the following speed profile 311, so that the intersection driving progression 321 of the modified speed profile 311 is also delayed in relation to the intersection driving progression 320 of the original speed profile 310. As a result thereof, the driving progression range 325 of the coasting mode can be extended, by which the energy efficiency of the vehicle 100 is increased.

To calculate the rollout curve 311, in addition to the actual coasting process, the current vehicle acceleration and/or the transition into coasting (for example, the time delay during the ramping down and/or during the decoupling of the internal combustion engine 103) can therefore be taken into consideration. Therefore, the current acceleration and/or a depiction of the transition into coasting can be taken into consideration at the beginning of the coasting rollout curve 311. The use of the coasting mode can thus be optimized.

FIG. 4 shows a flow chart of a (possibly computer-implemented) method 400 for controlling the coasting mode of a vehicle 100 in the context of (active) distance and/or speed control of the vehicle 100. In the context of the distance and/or speed control, the actual speed 301 of the vehicle 100 (during free driving) can be adjusted, in particular controlled, to a specific target speed 331. Alternatively or additionally, the actual distance 301 of the vehicle 100 to a preceding vehicle 200 (during a following journey) can be adjusted, in particular controlled, to a specific target distance 331. Proceeding from (active) distance and/or speed control, an entry into a coasting mode can be effected. During the coasting mode, an active adjustment (in particular control) of the distance and/or speed control can be suppressed and/or paused. However, it can be monitored in this case that the driving speed and/or the distance 301 remain within a tolerance band 335 around the target speed 331 and/or around the target distance 331. Upon exit from the coasting mode, the distance and/or speed control can be automatically resumed.

The method 400 comprises predicting 401 a distance and/or speed profile 311 of the vehicle 100 in the coasting mode in consideration of the movement of the vehicle 100 during a coasting entry phase 322 (which takes place during the entry into the coasting mode). In particular a drive and/or drag torque and/or a (positive or negative) acceleration of the vehicle 100 during the coasting entry phase 322 (which are caused by the drive motor 103 of the vehicle 100) can be taken into consideration here.

The method 400 furthermore comprises controlling 402, in particular starting (or entering into) or ending (or exiting from), the coasting mode in dependence on the predicted distance and/or speed profile 311.

Due to the consideration of the coasting entry phase 322 (during which the decoupling of the drive motor 103 from the one or more driven wheels is gradually effected) in the prediction of the distance and/or speed profile 311 of the vehicle 100 in the coasting mode, the accuracy of the predicted distance and/or speed profile 311 can be increased, by which the energy efficiency of the vehicle 100 can be increased.

The present invention is not restricted to the exemplary embodiments shown. In particular, it is to be noted that the description and the figures are only to illustrate the principle of the proposed methods, devices, and systems by way of example.

1.-12. (canceled)

13. A device for controlling a coasting mode of a vehicle in a context of distance and/or speed control of the vehicle, wherein the device is configured to
predict a distance and/or speed profile of the vehicle in the coasting mode in consideration of a movement of the vehicle during a coasting entry phase; and
control, to start or to end, the coasting mode in dependence on the predicted distance and/or speed profile.

14. The device according to claim 13, wherein the device is configured to take into consideration a drive and/or drag torque caused by a drive motor of the vehicle during the coasting entry phase and/or an acceleration of the vehicle caused by the drive motor during the coasting entry phase in ascertainment of the predicted distance and/or speed profile.

15. The device according to claim 13, wherein the coasting entry phase extends over a driving progression range which begins with an initial driving progression, at which a decoupling of a drive motor of the vehicle from one or more wheels of a drivetrain of the vehicle is initiated, and which ends with an end driving progression, at which the drive motor is completely decoupled from the drivetrain.

16. The device according to claim 14, wherein the coasting entry phase extends over a driving progression range which begins with an initial driving progression, at which a decoupling of the drive motor of the vehicle from one or more wheels of a drivetrain of the vehicle is initiated, and which ends with an end driving progression, at which the drive motor is completely decoupled from the drivetrain.

17. The device according to claim 13, wherein the device is configured to
ascertain a value of a drive and/or drag torque and/or an acceleration which is caused or was caused at an initial driving progression of the coasting entry phase by a drive motor of the vehicle on one or more wheels of a drivetrain of the vehicle; and
determine the predicted distance and/or speed profile based on the ascertained value of the drive and/or drag torque and/or the acceleration.

18. The device according to claim 14, wherein the device is configured to
ascertain a value of a drive and/or drag torque and/or an acceleration which is caused or was caused at an initial driving progression of the coasting entry phase by a drive motor of the vehicle on one or more wheels of a drivetrain of the vehicle; and
determine the predicted distance and/or speed profile based on the ascertained value of the drive and/or drag torque and/or the acceleration.

19. The device according to claim 15, wherein the device is configured to
ascertain a value of a drive and/or drag torque and/or an acceleration which is caused or was caused at an initial driving progression of the coasting entry phase by a drive motor of the vehicle on one or more wheels of a drivetrain of the vehicle; and
determine the predicted distance and/or speed profile based on the ascertained value of the drive and/or drag torque and/or the acceleration.

20. The device according to claim 13, wherein the device is configured to ascertain the predicted distance and/or speed profile under the assumption that if an influence of a roadway gradient is not taken into consideration a driving speed of the vehicle at the beginning of the predicted distance and/or speed profile remains unchanged for a specific driving progression range.

21. The device according to claim 14, wherein the device is configured to ascertain the predicted distance and/or speed profile under the assumption that if an influence of a roadway gradient is not taken into consideration a driving speed of the vehicle at the beginning of the predicted distance and/or speed profile remains unchanged for a specific driving progression range.

22. The device according to claim 15, wherein the device is configured to ascertain the predicted distance and/or speed profile under the assumption that if an influence of a roadway gradient is not taken into consideration a driving speed of the vehicle at the beginning of the predicted distance and/or speed profile remains unchanged for a specific driving progression range.

23. The device according to claim 20, wherein the device is configured to ascertain the specific driving progression range, in which the driving speed of the vehicle remains unchanged, based on the ascertained value of the drive and/or drag torque and/or the acceleration.

24. The device according to claim 13, wherein during the coasting entry phase,
a drive motor of the vehicle is decoupled from one or more wheels of a drivetrain of the vehicle; and/or
the drive motor is deactivated.

25. The device according to claim 14, wherein during the coasting entry phase,
the drive motor of the vehicle is decoupled from one or more wheels of a drivetrain of the vehicle; and/or
the drive motor is deactivated.

26. The device according to claim 15, wherein during the coasting entry phase,
the drive motor of the vehicle is decoupled from the one or more wheels of the drivetrain of the vehicle; and/or
the drive motor is deactivated.

27. The device according to claim 13, wherein
the predicted distance and/or speed profile indicates a temporal and/or spatial distance of the vehicle to a preceding vehicle driving in front of the vehicle and/or a driving speed of the vehicle as a function of the driving progression; and/or
the predicted distance and/or speed profile extends proceeding from a current driving progression over a predefined prediction horizon: and/or
the driving progression comprises
a position of the vehicle along a roadway traveled by the vehicle; and/or
a time during a journey of the vehicle.

28. The device according to claim 13, wherein the device is configured to
ascertain an upcoming gradient profile of a roadway traveled by the vehicle; and
predict the distance and/or speed profile of the vehicle in the coasting mode based on the upcoming gradient profile.

29. The device according to claim 13, wherein the device is configured to
ascertain status data with respect to a status of the vehicle and/or with respect to a status of a preceding vehicle driving in front of the vehicle; and
predict the distance and/or speed profile of the vehicle in the coasting mode based on the status data.

30. The device according to claim 13, wherein the device is configured to
compare the predicted distance and/or speed profile to a target speed or to a speed threshold value, lying below the target speed, of the distance and/or speed control; and/or
compare the predicted distance and/or speed profile to a target distance or to a distance threshold value, lying above the target distance, of the distance and/or speed control; and
control, to start or to end, the coasting mode in dependence on the comparison.

31. A method for controlling a coasting mode of a vehicle in a context of distance and/or speed control of the vehicle, the method comprising:
predicting a distance and/or speed profile of the vehicle in the coasting mode in consideration of a movement of the vehicle during a coasting entry phase; and
controlling, including starting or ending, the coasting mode in dependence on the predicted distance and/or speed profile.
